(19) United States
(12) Patent Application Publication
(10) Pub. No.: US 2014/0108943 A1
(43) Pub. Date: Apr. 17, 2014

(54) METHOD FOR BROWSING INTERNET OF THINGS AND APPARATUS USING THE SAME

(71) Applicant: KOREA ELECTRONICS TECHNOLOGY INSTITUTE, Seongnam-si (KR)

(72) Inventors: Sang-Shin LEE, Yongin-si (KR); Kwang-Ho WON, Yongin-si (KR); Jae-Ho KIM, Yongin-si (KR); Il-Yeup AHN, Namyangju-si (KR); Min-Hwan SONG, Seoul (KR); Jaeseok YUN, Yongin-si (KR)

(73) Assignee: KOREA ELECTRONICS TECHNOLOGY INSTITUTE, Seongnam-si (KR)

(21) Appl. No.: 14/052,091

(22) Filed: Oct. 11, 2013

(30) Foreign Application Priority Data
Oct. 16, 2012 (KR) 10-2012-0114878

(51) Int. Cl. G06F 3/0481

(52) U.S. Cl. CPC G06F 3/04817
USPC 715/738

(57) ABSTRACT

A method for browsing Internet of things (IoT) and an apparatus using the same are provided. In the method for browsing IoT, when a mobile device executes a browser, the browser receives information on IoT devices and displays the IoT devices on a map in the form of an icon. Accordingly, the browser displays the IoT devices on the map in the form of an icon, and provides various IoT services, so that the user can easily search for many IoT devices, connect them and receive services.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Oct. 16, 2012, and assigned Serial No. 10-2012-0114878, the entire disclosure of which is hereby incorporated by reference.

### TECHNICAL FIELD OF THE INVENTION

Methods and apparatuses consistent with exemplary embodiments relate to a method for browsing Internet of things (IoT) and an apparatus using the same, and more particularly, to a method for browsing IoT, which can systematically provide IoT services for various things, and an apparatus using the same.

### BACKGROUND OF THE INVENTION

The term “Internet of things (IoT)” appeared for the first time in the Auto-ID lab at MIT in 1998. After that, as the ITU-T announced the annual report “The Internet of Things” in 2005, it predicted that the IoT would be the most fundamental frame containing all structures of future IT industry revolution. The report defined the IoT as “a new information communication infrastructure that connects all kinds of things existing in the world through networks and enables persons and things to communicate with each other anytime and anywhere”. That is, the IoT can truly be seen as an infrastructure to realize a ubiquitous space. Such a ubiquitous space starts by implanting computing devices equipped with specific functions into environments and things and making the environment and the things intelligent.

The IoT service provides a more convenient and safe life to us. Therefore, various telecommunication companies and terminal manufacturers are focusing on development of terminals and services for supporting IoT to emerge as a next generation mobile service.

However, the IoT is at an early stage and does not propose a detailed model for providing the service. Therefore, there is a need for a detailed method for providing such an IoT service.

### SUMMARY OF THE INVENTION

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a browser through which a user can easily search for many IoT devices, connect them, and receive services from the IoT devices.

One or more exemplary embodiments also provide an open software platform to provide an IoT service. Through the suggested open IoT software platform, time and cost that are required to develop the IoT service can be saved and thus many developers can be easily encouraged to develop the IoT services.

The open software platform for providing such a service is divided into four platforms according to functions. The open IoT software platform includes a D-platform to connect things to the Internet to develop the open IoT software platform, a P-platform to register IoT devices and provide a search service in the global environment, and an S-platform which is an App store platform for an IoT application service environment in case that IoT application increases geometrically, and an M-platform to provide various mash-up services.

According to an aspect of an exemplary embodiment, there is provided a method for browsing Internet of things (IoT) of a mobile device, the method including:executing, by the mobile device, a browser; receiving, by the browser, information on IoT devices; and displaying, by the browser, the IoT devices on a map in a form of an icon.

The displaying may include displaying an icon of an IoT device that is accessible and an icon of an IoT device that is inaccessible in different forms.

The displaying may include displaying the icon of the IoT device that is accessible in color and displaying the icon of the IoT device that is inaccessible in black and white.

The executing may include, when an IoT browser icon is selected or a specific code is read on an initial screen by a user, executing, by the mobile device, an IoT browser.

The displaying may include, when the IoT devices are superimposed one on another on a specific area, displaying a plural IoT device icon displaying a number of corresponding IoT devices.

The method may further include, when the icon is selected, displaying, by the IoT browser, an application list screen corresponding to an IoT device corresponding to the selected icon, and the application list screen may display different buttons on corresponding application items according to whether each application is installed or not and whether each application is updated or not.

The method may further include providing a favorite list on specific locations or specific IoT devices.

According to an aspect of another exemplary embodiment, there is provided a computer readable recording medium on which software for executing the method for browsing the IoT as claimed in any one of claims 1 to 7 is recorded.

According to various exemplary embodiments, the browser displays the IoT devices on the map in the form of icons or list, and provides various IoT services, so that the user can easily search for many IoT devices, connect them and receive services.

### BRIEF DESCRIPTION OF THE DRAWINGS

The above and/or other aspects will be more apparent by describing in detail exemplary embodiments, with reference to the accompanying drawings, in which:

FIG. 1 is a view illustrating a configuration of an IoT software platform according to an exemplary embodiment;

FIG. 2 is a flowchart to illustrate a process in which a smart device user uses an IoT service using his/her own smart device according to an exemplary embodiment;

FIG. 3 is a view illustrating a screen of a map-based IoT browser which is displayed on a screen of a smart device according to an exemplary embodiment;

FIG. 4 is a view illustrating a method for executing an IoT browser by a user selecting an icon according to an exemplary embodiment;

FIG. 5 is a view illustrating a method for executing an IoT browser using a QR code according to an exemplary embodiment;

FIG. 6 is a view illustrating a screen of an IoT browser on which a plurality of IoT devices are displayed simultaneously according to an exemplary embodiment;

FIG. 7 is a view illustrating an IoT browser screen which displays detailed information of a specific IoT device according to an exemplary embodiment;

FIG. 8 is a view illustrating an application list screen corresponding to a specific IoT device according to an exemplary embodiment;

FIG. 9 is a view illustrating a location favorite list screen according to an exemplary embodiment;

FIG. 10 is a view illustrating an IoT device favorite list screen according to an exemplary embodiment; and

FIG. 11 is a view illustrating a base map setting screen according to an exemplary embodiment.

### DETAILED DESCRIPTION OF THE INVENTION

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

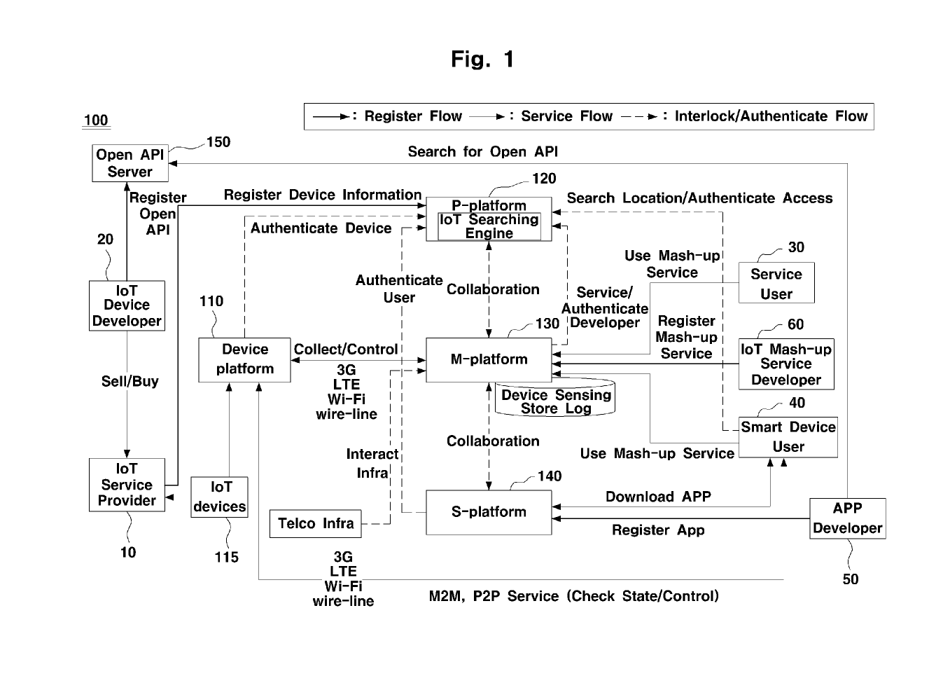

FIG. 1 is a view illustrating a configuration of an IoT software platform 100 according to an exemplary embodiment. As shown in FIG. 1, the IoT software platform 100 includes a D-platform 110, a P-platform 120, an M-platform 130, and an S-platform 140.

The D-platform 110 refers to a software platform that is installed at an IoT device 115 side, and the P-platform 120, the M-platform 130, and the S-platform 140 refer to software platforms that are installed at a server computer side separately or altogether.

The D-platform 110, which is an abbreviation of “Device platform”, may be directly installed in the IoT device 115 or installed in an IoT adaptor mounted in the IoT device 115, and may be interlocked with the P-platform 120 and the M-platform 130 and also may be interlocked with a smart device through an IoT application and an IoT website.

The IoT device 115 recited herein refers to general things to which the IoT is applied (for example, a TV, a mobile phone, a refrigerator, a washing machine, a vending machine, etc.).

The IoT adaptor is mounted in the IoT device 115 and enables the IoT device 115 to use IoT communication. The IoT adaptor includes a communication module to communicate through at least one of near field communication (NFC), Wi-Fi, Ethernet, 3^{rd} Generation (3G), and long term evolution (LTE), and the D-platform 110 installed in the IoT adaptor provides various functions to be able to perform IoT communication.

The P-platform 120, which is an abbreviation of “Planet platform”, performs functions like managing the IoT devices 115, managing the user, monitoring the IoT devices 115, and searching for the IoT devices 115. Specifically, the P-platform 120 receives information on the IoT devices 115 from an IoT service provider 10 and registers the IoT devices 115. At this time, the information on the IoT devices 115 includes a device ID, a device name, a model name, a manufacturer, location information and device state information, and includes an address which is necessary when the IoT devices are connected (for example, an IP address, MSISDN, etc.).

The P-platform 120 authenticates a user who accesses the S-platform 130 to register and download an IoT application for an IoT service. The P-platform 120 stores personal information such as ID/PW and telephone number of the user to authenticate the user.

Also, the P-platform 120 may authenticate a developer who develops and registers an IoT-related mash-up service or a service user who uses a mash-up service.

In addition, the P-platform 120 may authenticate IoT service access of an IoT service user using an application of a smart device (for example, a smartphone, a tablet, etc.).

The M-platform 130, which is an abbreviation of “Mash-up platform”, communicates with the D-platform 110 and forwards a control command of the service user using the IoT application or the IoT webpage to the IoT device 115.

The M-platform 130 registers an IoT mash-up service which is developed by a mash-up service developer 60. That is, the mash-up service developer 60 develops the IoT mash-up service and registers it at the M-platform 130. At this time, the mash-up service developer 60 may develop the IoT mash-up service using an IoT open application programming interface (API) provided by an open API server 150.

The IoT devices 115 transmit data generated by them to the M-platform 130 periodically, and accordingly, the M-platform 130 collects the data generated by the IoT devices 115 and stores the data as a log, such that the data is used to provide various IoT mash-up services to the service user.

Also, the M-platform 130 may charge for the use of the IoT mash-up service and may store brief information on the IoT devices 115 (for example, ID, IP address, etc.).

The S-platform 140, which is an abbreviation of “Store platform”, provides an application store function of providing an IoT application for an IoT service to the service user. To achieve this, the S-platform 140 provides an application search function. The S-platform 140 may search for an IoT application with reference to the ID of the IoT device 115 for the user to use an IoT function of the IoT device 115.

To achieve this, the S-platform 140 registers an IoT application which is developed by an IoT application developer 50.

The open API server 150 manages and provides an open API related to the IoT service. Specifically, the development company of the IoT device 115 develops the open API on the IoT device 115 when manufacturing the IoT device 115, and registers and stores the relevant open API at the open API server 150. That is, the open API server 150 may register, store, and manage various open APIs on the IoT devices 115 developed by various development companies.

The open API server 150 provides the stored open API to a developer who wants to develop an IoT service-related website, a mash-up service site, and an application. Accordingly, the developers are provided with relevant open APIs by the open API server 150 when developing the IoT service-related web-site, the mash-up service site, and the application, and develop the IoT services using the open APIs.

For example, when an IoT device manufacturer registers an open API which provides state information on the IoT device 115 (for example, information on whether the IoT device 115 is out of order or not) at the open API server 150, the developer may search for the open API providing the state information from the open API server 150 and use the open API, and may implement a function of inquiring about the state of the IoT device 115 in the IoT service-related website, the mash-up service site, and the IoT application.

On the other hand, the IoT service user may directly access the IoT device 115 using an IoT application downloaded into a smart device 40, which is a kind of a mobile device, and may use the IoT service. At this time, the IoT device 115 may be connected with the smart device 40 by means of relay of the M-platform 130 or may be directly connected with the smart device 40 through peer to peer (P2P) communication and may provide the IoT service. In this case, the D-platform 110 of the IoT device 115 may indirectly communicate with the IoT application of the smart device 40 by means of relay of the M-platform 130 or may directly communicate with the IoT application using P2P communication.

The IoT software platform 100 having the above-described configuration has the D-platform 110, the P-platform 120, the M-platform 130, and the S-platform interlocked with one another, and provides various IoT services.

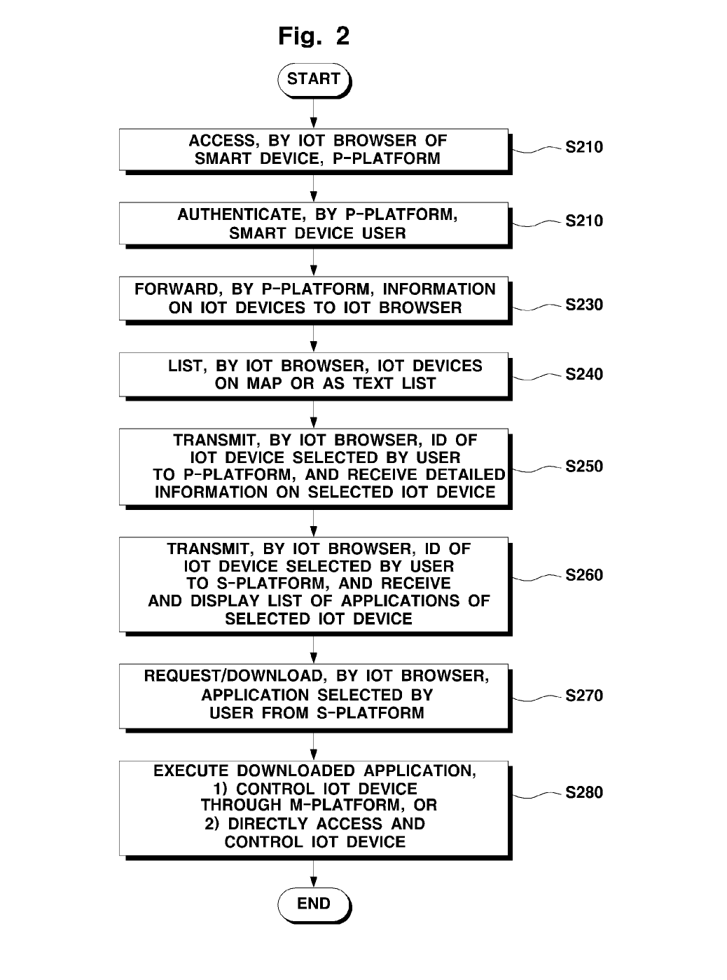

Hereinafter, a process in which the user of the smart device 40 uses an IoT service will be explained with reference to FIG. 2. FIG. 2 is a flowchart to illustrate a process in which the user of the smart device 40 uses the IoT service using the smart device 40.

When the user of the smart device 40 executes an IoT browser using the smart device 40, the IoT browser accesses the P-platform 120 (S210), and the P-platform 120 performs authentication to determine whether the user of the smart device 40 has an authority to use the IoT service or not (S220).

When the user of the smart device 40 is an authorized user, the P-platform 120 forwards information on IoT devices to be displayed on the IoT browser (S230), and the IoT browser lists the IoT devices forwarded from the P-platform 120 (S240).

In operation S240, the IoT devices may be listed in the form of icons on a map or in the form of a text list.

When one of the IoT devices listed in operation S240 is selected by the service user, the IoT browser forwards the ID of the selected IoT device to the P-platform 120 and receives detailed information on the selected IoT device 115 from the P-platform 120 (S250). The detailed information may be displayed on the IoT browser at a request of the user of the smart device 40.

Also, the IoT browser forwards the ID of the selected IoT device to the S-platform 140, and receives an application list regarding the selected IoT device 115 from the S-platform 140 and displays the application list (S260). The applications displayed in operation S260 are applications for controlling the selected IoT device 115 remotely and receiving a mash-up service related to the selected IoT device 115.

Next, when one of the applications listed in the application list displayed in operation S260 is selected by the service user, the IoT browser requests the selected application from the S-platform 140 and downloads the application (S270).

After that, the smart device 40 executes the application downloaded in operation S270 and controls an operation of the IoT device 115 (S280).

Specifically, the smart device 40 may execute the downloaded application, access the D-platform 110 mounted in the IoT device 115 through the M-platform 130, and then control the operation of the IoT device 115.

When the M-platform 130 is not necessary in the middle according to a service, the smart device may execute the application downloaded in operation S270, directly access the D-platform 110 mounted in the IoT device 115, and control the operation of the IoT device 115.

Also, the smart device may execute the application downloaded in operation S270 and may be provided with the IoT mash-up service by the M-platform 130.

Through the above-described process, the IoT software platform 100 has the D-platform 110, the P-platform 120, the M-platform 130, and the S-platform 140 interlocked with one another and provides the IoT service through the application.

In FIG. 2, the smart device 40 executes the downloaded application, accesses the D-platform 110 mounted in the IoT device 115, and controls the operation of the IoT device 115, or accesses the M-platform 130 and receive the IoT mash-up service.

However, the smart device 40 may control the IoT device 115 or receive the IoT mash-up service by accessing an IoT web page for controlling the IoT device 115 and providing the IoT mash-up service, rather than using the downloaded application.

Also, in the above-described exemplary embodiment, the IoT device is selected using the IoT browser. However, the IoT device may be selected in various ways. For example, the IoT device may be searched/selected by directly inputting an ID or a name of the IoT device, or may be selected by searching for a category of the IoT device. Also, the IoT device may be selected by obtaining an ID of the IoT device from a QR code attached to the IoT device, or may be selected by obtaining the ID using short-range communication such as NFC, Zigbee, Bluetooth, etc.

Hereinafter, the above-described IoT browser will be explained in detail. The IoT browser provides a function of allowing the user to search for and select an IoT devices on a map or a list, and a function of displaying a link connected to an application corresponding to the IoT device.

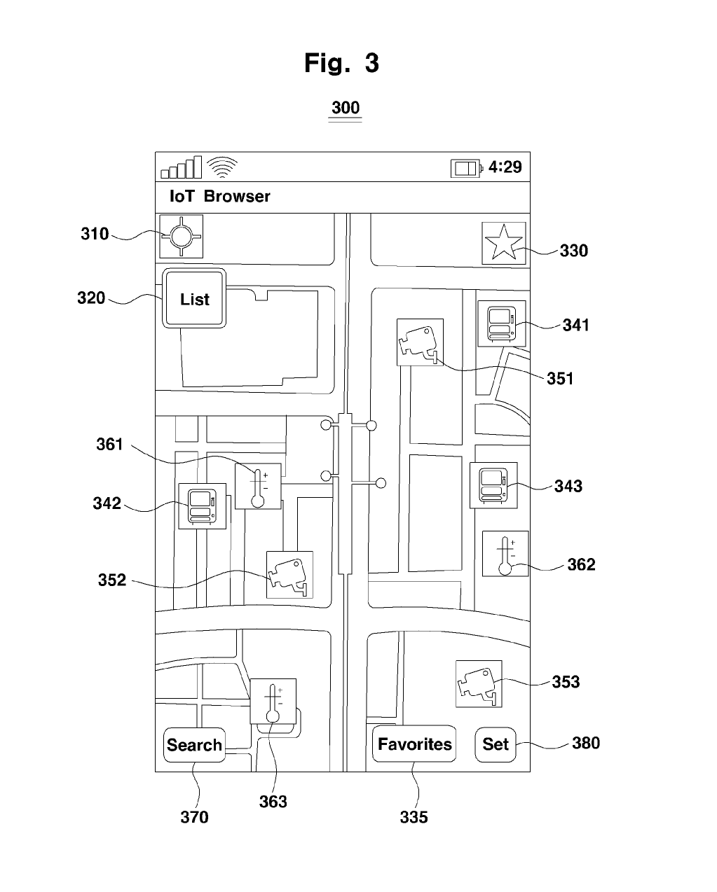

FIG. 3 is a view illustrating a screen of a map-based IoT browser 300 which is displayed on a screen of the smart device 40 according to an exemplary embodiment. When the IoT browser is executed in the smart device 40 by the user, the smart device 40 authenticates the user through the P-platform, receives information on the IoT devices, and displays the IoT devices on the IoT browser 300.

As shown in FIG. 3, the IoT browser 300, which is executed in the smart device 40 and displayed on the screen, displays icons 341, 342, 343, 351, 352, 353, 361, and 362 corresponding to various IoT devices on the map. The locations of the icons indicate locations of the IoT devices. Specifically, it can be seen from FIG. 3 that the IoT browser 300 displays icons corresponding to IoT vending machines 341, 342, and 343, IoT surveillance cameras 351, 352, and 353, and IoT thermometers 361 and 362.

Also, the IoT browser 300 may display an icon of an IoT device that is accessible and an icon of an IoT device that is inaccessible in different forms. Specifically, the IoT browser 300 may display the icon of the IoT device that is accessible in color, and may display the icon of the IoT device that is inaccessible in black and white. For example, as shown in FIG. 3, the IoT browser 300 may display the first IoT thermometer 361 and the second IoT thermometer 362 in black and white to indicate that they are inaccessible, and may display a third IoT thermometer 363 in color to indicate that it is accessible.

The IoT browser 300 displays a current location icon 310, a list view icon 320, a favorite register icon 330, a favorite list icon 335, a search icon, and a setting icon 380. The current location icon 310 is an icon that performs a function of moving to a current location of the user on the map.

The list view icon 320 performs a function of converting the IoT browser 300 from a map-based mode into a list-based mode. When the list view icon 320 is selected, the IoT browser 300 displays the IoT devices currently displayed on the screen in the form of a list.

The favorite register icon 330 is displayed in the shape of a star and performs a function of allowing the user to register a location currently displayed on the map or a currently selected IoT device 115 as a favorite. That is, when the map is displayed and the user selects the favorite register icon 330, the IoT browser 300 registers a center area of the currently displayed map as a favorite.

Also, when information on the IoT device 115 is displayed and the user selects the favorite register icon 330, the IoT browser 300 registers the IoT device 115 as a favorite.

The favorite list icon 335 displays a favorite list which is a list of IoT devices or locations that are set as favorites by the user. Specifically, when the favorite list icon 335 are selected, the IoT browser 300 displays the favorite list in the form of a pop-up window.

The setting icon 380 displays a setting screen for adjusting various setting values of the IoT browser 300. The IoT browser 300 may display menus to set a base map, a user ID, a user password, whether to display only an activated IoT device or not, a search term tag, a number of IoT devices that are displayed on a single screen, etc. on the setting screen.

As described above, the IoT browser 300 displays icons of various functions on the screen.

Also, the IoT browser 300 may be displayed in a different layout according to a resolution of the smart device 40. Also, the IoT browser 300 may be configured using the base map set by the user (for example, one of Daum Map, Naver Map, and Google Map).

Also, the IoT browser 300 may select a map area to be initially displayed in various methods. The first method is receiving initial area setting information on a map area to be initially displayed from the P-platform 120 and determining the map area to be initially displayed according to the received initial area setting information. The second method is displaying the area that was displayed last as a map area to be initially displayed. The third method is displaying a current location of the user as a map area to be initially displayed.

As described above, the IoT browser 300 may display a variety of IoT devices based on the map, and, when a specific IoT device is selected, may display a list of applications corresponding to the selected IoT device, and may download and install an application.

Hereinafter, two methods for executing the IoT browser 300 will be explained. When the user selects an IoT browser icon or has a specific code read on an initial screen, the IoT browser 300 may be executed.

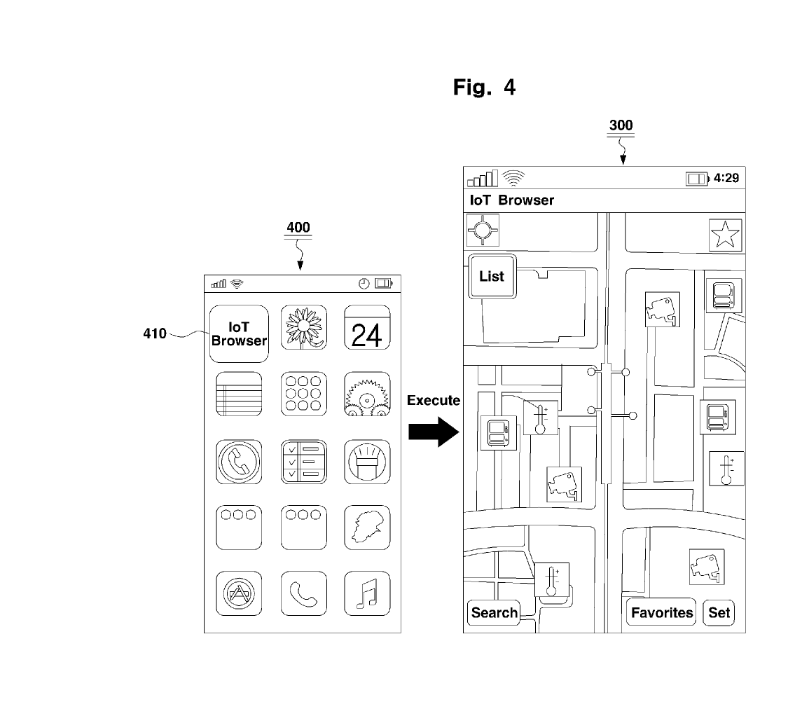

FIG. 4 is a view illustrating a first method for executing the IoT browser 300 by the user selecting an icon according to an exemplary embodiment. After the IoT browser 300 is downloaded and installed by the user, an IoT browser icon 410 is displayed on an initial screen 400 of the smart device 40 as shown in FIG. 4. When the IoT browser icon 410 is selected by the user, the smart device 40 executes the IoT browser 300 and displays it on the screen.

As described, the user may execute the IoT browser 300 by selecting the initial screen icon.

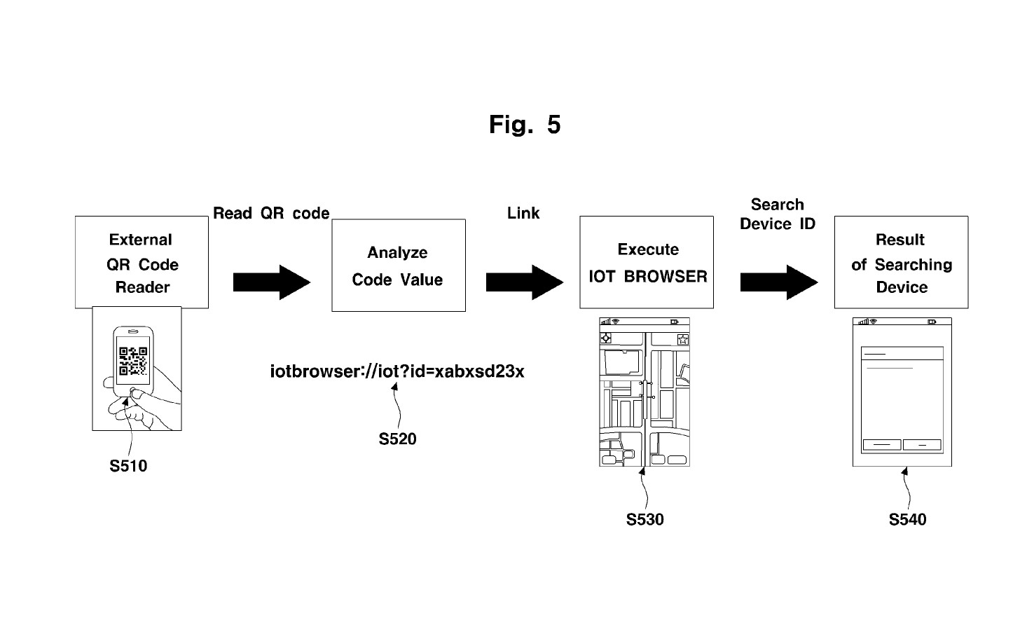

FIG. 5 is a view illustrating a second method for executing the IoT browser 300 using a QR code according to an exemplary embodiment. The QR code is merely an example and the smart device 40 may execute the IoT browser 300 using a specific code which is obtained through various code means (for example, a bar code, a QR code, an RFID, NFC, etc.)

Specifically, the smart device 40 reads a QR code corresponding to the IoT devices 115 first (S510). The QR code corresponding to the IoT device 115 may be attached to the IoT device 115 or may be located nearby. The QR code includes a code value corresponding to information of the IoT device 115 in such a form that the code value can be executed in the IoT browser 300. The code value may include ID information of the IoT device 115.

After that, the smart device 40 analyzes the QR code and extracts the code value. Specifically, the smart device 40 may extract the code value of the QR code in the form corresponding to the information of the IoT device 115 like “iotbrowser://lot?id=xabxsd23x” as shown in FIG. 5.

The smart device 40 executes the IoT browser 300 using the extracted code value, and displays the IoT browser 300 on the screen (S530). At this time, the smart device 40 obtains location information of the IoT device 115 from the P-platform 120 using the extracted code value, and displays a map area corresponding to the location information of the IoT device 115 on the initial screen of the IoT browser 300.

The smart device 40 searches for the IoT device 115 using the ID of the IoT device 115 included in the extracted code value, and displays a result of the searching on the screen (S540).

By reading the QR code using the smart device 40 through the above-described process, the user may directly search for and select the IoT device 115 corresponding to the QR code on the IoT browser 300.

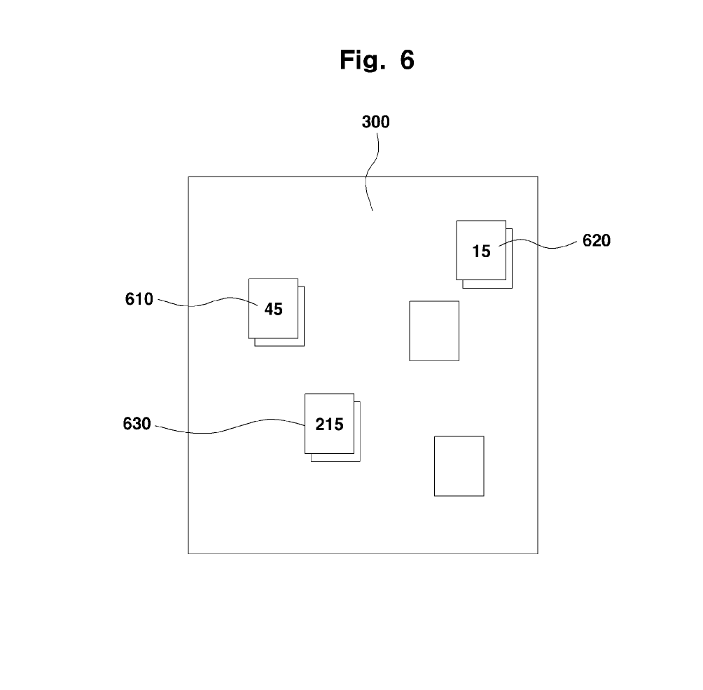

FIG. 6 is a view illustrating a screen of the IoT browser 300 on which a plurality of IoT devices are displayed simultaneously according to an exemplary embodiment. When the IoT devices are superimposed one on another on a specific area, the IoT browser 300 displays plural IoT device icons 610, 620, and 630 on the screen, as shown in FIG. 6.

The plural IoT device icons 610, 620, and 630 each are icons representing the plurality of IoT devices. The plural IoT device icons 610, 620, and 630 include numbers therein to indicate a number of IoT devices.

Therefore, the first plural IoT device icon 610 represents 45 Iot devices, the second plural IoT device icon 620 represents 15 IoT devices, and the third plural IoT device icon 630 represents 215 IoT devices.

Also, when a specific manipulation (for example, double touch or double click) is input to the plural IoT device icon 610, 620, or 630, the IoT browser 300 increases a zoom level of the map with reference to the plural IoT device icon to which the manipulation is input, and displays the map. When the zoom level reaches the maximum value, the IoT browser 300 may display a list of IoT devices corresponding to the plural IoT device icon on the screen.

The IoT browser 300 may link a virtual device ID or a representative device ID to the plural IoT device icon 610, 620, or 630.

As described above, the IoT browser 300 may display the plural IoT device icon representing the plurality of IoT devices.

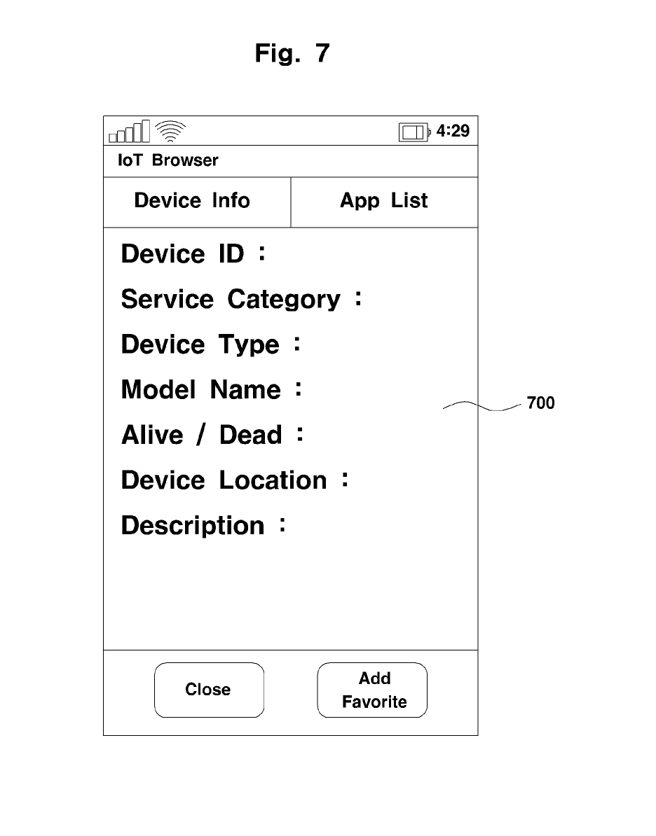

FIG. 7 is a view illustrating a screen of the IoT browser 300 on which detailed information on a specific IoT device 115 is displayed according to an exemplary embodiment.

When the user selects an icon of a specific IoT device 115 from among the icons 341, 342, 343, 351, 352, 353, 361, and 362 corresponding to the IoT devices displayed on the IoT browser 300 of FIG. 3, the IoT browser 300 may display a detailed information screen 700 of the IoT device 115 corresponding to the selected icon. The detailed information screen 700 may include information like a device ID of the IoT device 115, a service category, a device type, a model name, information on whether the device is alive/dead, device location information, device description, etc.

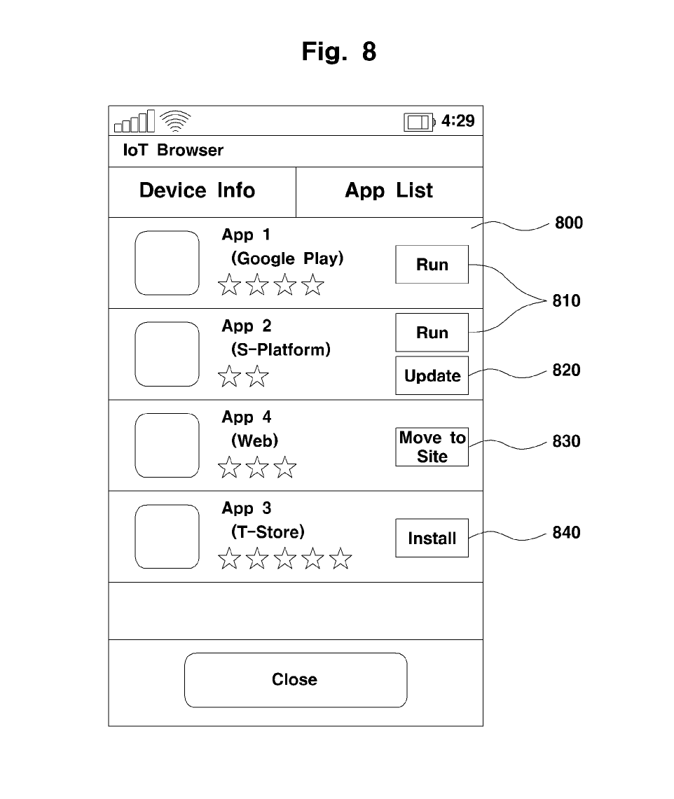

FIG. 8 is a view illustrating an application list screen 800 corresponding to a specific IoT device 115 according to an exemplary embodiment.

When the user selects an icon of a specific IoT device 115 from among the icons 341, 342, 343, 351, 352, 353, 361, and 362 corresponding to the IoT devices displayed on the IoT browser 300 of FIG. 3, the IoT browser 300 may display the application list screen 800 on the IoT device 115 corresponding to the selected icon as shown in FIG. 8.

The application list screen 800 is a screen that displays a list of applications through which the user accesses and controls the specific IoT device 115 and uses an IoT service. Specifically, the IoT browser 300 asks the S-platform 140 for an application list corresponding to the IoT device 115 and receives the application list, and displays the application list screen 800 using the received application list. For example, it can be seen from FIG. 8 that there are four applications, App 1, App 2, App 3, and App 4 to access the specific IoT device 115.

The IoT browser 300 displays different buttons on application items according to whether the application is installed or not and whether the application is updated or not. Specifically, when the latest version of the application corresponding to the list is installed in the smart device 400, the IoT browser 300 displays a “run” button 810. When the previous version of the application corresponding to the list is installed in the smart device 40, the IoT browser 300 displays an “update” button 820 along with the “run” button 810. Also, when the application corresponding to the list is not installed in the smart device 40, the IoT browser 300 displays an “install” button 840. That is, it can be seen from FIG. 8 that the latest version of App 1 is installed, the previous version of App 2 is installed, and App 3 is not installed.

When the “run” button 810 is selected by the user, the IoT browser 300 executes the corresponding application. When the “update” button 820 is selected by the user, the IoT browser 300 downloads update data from the S-platform 140 and updates the corresponding application. When the “install” button 840 is selected by the user, the IoT browser 300 downloads the corresponding application from the S-platform 140 and installs it in the smart device 40.

Also, the IoT browser 300 may display a “link” button 830 which is linked to a web site on the application list screen 800. For example, in FIG. 8, “App 4” is an item that indicates a website link providing an IoT service for the specific IoT device 115. Accordingly, when the user selects “App 4”, the IoT browser 300 displays a corresponding website on the screen.

As described above, the user may easily install and use the application for using the IoT service for the IoT device 115 through the application list screen 800.

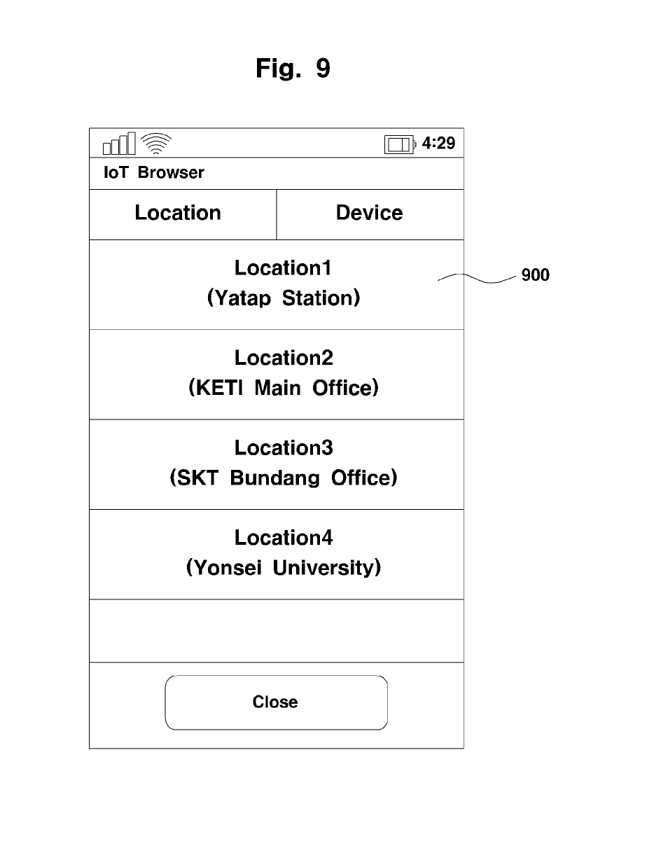

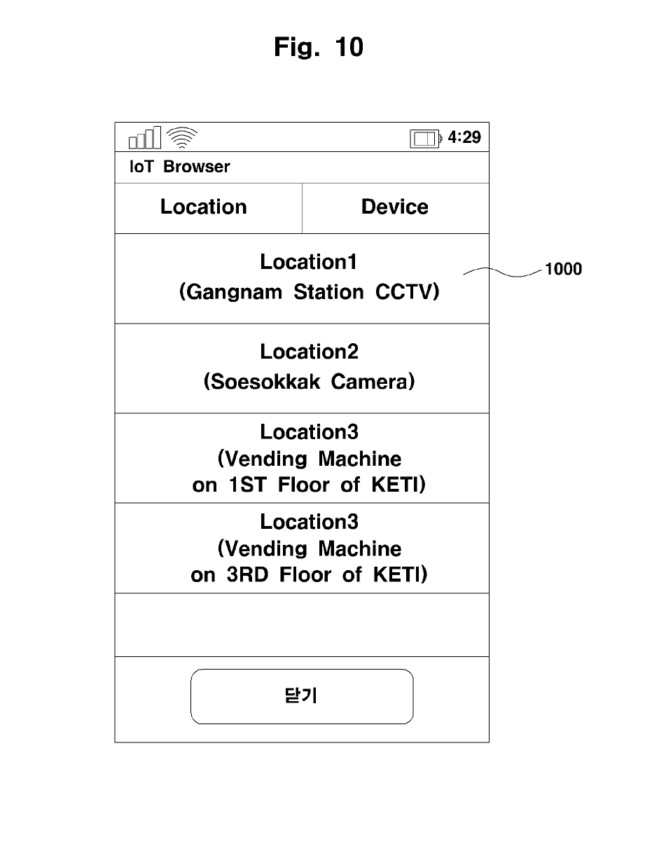

Hereinafter, a favorite screen of the IoT browser 300 will be explained with reference to FIGS. 9 and 10. The IoT browser 300 may provide a favorite list on specific locations or specific IoT devices.

FIG. 9 is a view illustrating a location favorite list screen 900 according to an exemplary embodiment.

The IoT browser 300 may register specific locations as favorites. Specifically, the favorite register icon 330 may be displayed in the shape of a star as shown in FIG. 3, and may allow the user to register a location currently displayed on the map or a currently selected IoT device 115 as a favorite. That is, when the map is displayed and the user selects the favorite register icon 330, the IoT browser 130 registers a center area of the currently displayed map as a favorite.

Also, when the favorite list icon 335 shown in FIG. 3 is selected by the user, the IoT browser 300 displays the location favorite list screen 900 which is a list of locations set by the user as favorites. As shown in FIG. 9, the location favorite list screen 900 shows that various locations selected by the user are registered. When a specific item is selected on the location favorite list screen 900, the IoT browser 300 displays a map with reference to the location corresponding to the selected item.

FIG. 10 is a view illustrating an IoT device favorite list screen 1000 according to an exemplary embodiment.

The IoT browser 300 may register specific IoT devices as favorites. Specifically, the favorite register icon 330 may be displayed in the shape of a star and may allow the user to register a location currently displayed on the map or a currently selected IoT device 115 as a favorite. When detailed information of the IoT device is displayed as shown in FIG. 7 and the favorite register icon is selected, the IoT browser 130 may register the currently displayed IoT device as a favorite.

Also, when the favorite list icon 335 shown in FIG. 3 is selected by the user, the IoT browser 300 displays the IoT device favorite list screen 1000 which is a list of IoT devices set by the user as favorites.

As shown in FIG. 10, the IoT device favorite list screen 1000 shows that various IoT devices selected by the user are registered. When a specific item is selected on the IoT device favorite list screen 1000, the IoT browser 300 displays a map with reference to the location of the IoT device corresponding to the selected item.

As described above, the IoT browser 300 provides the favorite find function on locations or IoT devices.

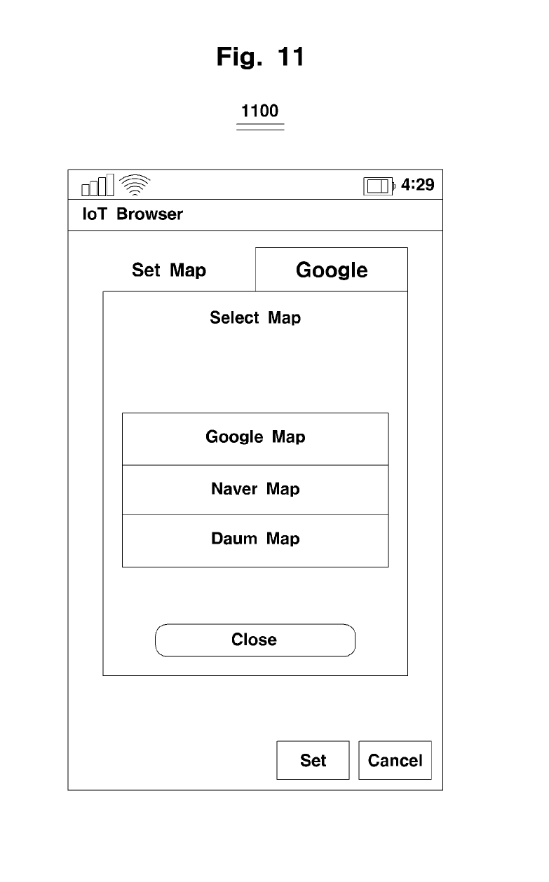

FIG. 11 is a view illustrating a base map setting screen 1100 according to an exemplary embodiment.

When the setting icon 380 shown in FIG. 3 is selected by the user, the IoT browser 300 may display the base map setting screen 1100 as shown in FIG. 11. The base map setting screen 1100 may be a screen through which the user selects a base map to display locations of the IoT devices on the IoT browser 300, and may display a list of various maps as shown in FIG. 11. When a specific map is selected by the user, the IoT browser 300 uses the map selected by the user as a base map and displays the locations of the IoT devices.

The IoT software platform 100, the D-platform 110, the P-platform 120, the M-platform 130, and the S-platform 140 according to an exemplary embodiment are not limited by their respective names and may be applied to any software, electronic apparatus or system that corresponds to the corresponding functions.

Also, the IoT software platform 100, the D-platform 110, the P-platform 120, the M-platform 130, and the S-platform 140 may have various forms other than the software platform, such as library, software solution, software package, software framework, individual software, etc.

The technical idea of the exemplary embodiments may be applied to a computer readable recording medium on which a computer program to perform the above-described functions of the IoT browser 300 is recorded. Also, the technical idea of the exemplary embodiments may be implemented in the form of a computer readable code which is recorded on a computer readable recording medium. The computer readable recording medium may include all kinds of data storage apparatuses that can be read by a computer and can store data. For example, the computer readable recording medium may be a read only memory (ROM), a random access memory (RAM), a CD-ROM, a magnetic tape, a floppy disk, an optical disk, a hard disk drive, etc. The computer readable code or program which is stored in the computer readable recording medium may be transmitted through a network which is connected among computers.

The smart device 40 according to an exemplary embodiment may be substituted with any mobile device that can execute the IoT browser to provide the IoT service, besides a smartphone and a tablet PC.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

1. A method for browsing Internet of things (IoT) of a mobile device, the method comprising:
executing, by the mobile device, a browser;
receiving, by the browser, information on IoT devices; and
displaying, by the browser, the IoT devices on a map in a form of an icon.

2. The method as claimed in claim 1, wherein the executing comprises, when an IoT browser icon is selected or a specific code is read on an initial screen by a user, executing, by the mobile device, an IoT browser.

3. The method as claimed in claim 1, wherein the displaying comprises, when the IoT devices are superimposed one on another on a specific area, displaying a plural IoT device icon displaying a number of corresponding IoT devices.

4. The method as claimed in claim 1, further comprising, when the icon is selected, displaying, by the IoT browser, an application list screen corresponding to an IoT device corresponding to the selected icon,
wherein the application list screen displays different buttons on corresponding application items according to whether each application is installed or not and whether each application is updated or not.

5. The method as claimed in claim 1, further comprising providing a favorite list on specific locations or specific IoT devices.

6. The method as claimed in claim 1, wherein the displaying comprises displaying an icon of an IoT device that is accessible and an icon of an IoT device that is inaccessible in different forms.

7. The method as claimed in claim 6, wherein the displaying comprises displaying the icon of the IoT device that is accessible in color and displaying the icon of the IoT device that is inaccessible in black and white.

8. A computer readable recording medium on which software for executing the method for browsing the IoT as claimed in claim 1 is recorded.
